(19) United States
(12) Patent Application Publication
(10) Pub. No.: US 2023/0201059 A1
(43) Pub. Date: Jun. 29, 2023

(54) VERTICAL SOFT U-SHAPED OPENING AND CLOSING SEALED AIR-PRESSURE CHAMBER

(71) Applicant: Shanghai Baobang Medical Equipment Co., Ltd, Shanghai (CN)

(72) Inventor: Zongbing Pan, Shanghai (CN)

(73) Assignee: Shanghai Baobang Medical Equipment Co., Ltd, Shanghai (CN)

(21) Appl. No.: 17/908,376

(22) PCT Filed: May 20, 2021
(86) PCT No.: PCT/CN2021/094820

§ 371 Date: Aug. 31, 2022

(30) Foreign Application Priority Data
Aug. 30, 2020 (CN) 202010891355.X

(51) Int. Cl. A61G 10/02; E06B 7/22

(52) U.S. Cl. CPC A61G 10/02; E06B 7/22

(57) ABSTRACT

The present invention discloses a vertical soft U-shaped opening and closing sealed air-pressure chamber, comprising a chamber body and an outer zipper strip. The outer zipper strip is a U-shaped structure and installed in a front-end surface of a chamber door. A U-shaped sealing strip is arranged in a middle position between an inner zipper slider and an outer zipper slider. The chamber body is sealed in a U-shaped way, which can be adapted to various soft air pressure chambers. Whether a human body or the human body carried in a wheelchair or a cart is very convenient to enter the chamber body.

### TECHNICAL FIELD

The present invention relates to the technical field of a physical therapy rehabilitation medical apparatus of a human body or an animal, particularly to a vertical soft U-shaped opening and closing sealed air-pressure chamber.

### BACKGROUND

A soft air-pressure chamber has a very wide application range, and is mainly configured to treat an air embolism disease, a decompression disease, hypoxic-ischemic encephalopathy, brain trauma, cerebrovascular disease, etc.

An opening and closing sealing method of the soft air-pressure chamber in the prior art is an opening and closing method of one straight zipper. An opening is very narrow and needs to be opened to both sides so that a human body or an animal can enter the chamber body, which is very inconvenient to use. It is impossible for a person with inconvenient mobility to enter the chamber body by means of a wheelchair cart, etc., which cannot meet the needs of people. In view of the above situation, technological innovation is carried out on the basis of the vertical soft U-shaped opening and closing sealed air-pressure chamber in the prior art.

### SUMMARY

An objective of the present invention is to provide a vertical soft U-shaped opening and closing sealed air-pressure chamber so as to solve the following problems: an opening and closing sealing method of a soft air-pressure chamber in the background is an opening and closing method of one straight zipper; an opening is very narrow and needs to be opened to both sides so that a human body or an animal can enter the chamber body, which is very inconvenient to use; further, it is impossible for a person with inconvenient mobility to enter a chamber body by means of a wheelchair or a cart, etc., which cannot meet needs of people.

In order to achieve the above objective, the present invention provides the following technical solution: a vertical soft U-shaped opening and closing sealed air-pressure chamber comprises a chamber body and an outer zipper strip. A chamber door is installed on a front-end surface of the chamber body. A lower end of the chamber door is provided with a folding line. The outer zipper strip is installed on a front end surface of the chamber door. An outer zipper slider is installed at an end of the outer zipper strip. An inner zipper strip is installed on a rear end surface of the chamber door. An inner zipper slider is installed at an end of the inner zipper strip. A sealing strip is arranged at a middle position between the outer zipper slider and the inner zipper slider. An inner zipper strip fixing sheet is installed on a right side of the sealing strip. A connecting point is provided on a left side of the sealing strip. The outer zipper strip and the inner zipper strip both have U-shaped structures.

Preferably, a material of the chamber body is a soft material. An air inlet is installed a right end surface of the chamber body. A pressure gauge is installed on a left end surface of the chamber body. A manual pressure-relief valve is installed below the pressure gauge. Constant-pressure valves are installed on a left side and a right side of the rear end surface of the chamber body. A transparent window is installed inside the chamber door.

Preferably, the outer zipper strip is stitched with the chamber door. The inner zipper strip is stitched with the chamber door.

Preferably, the inner zipper strip is stitched with the inner zipper strip fixing sheet. The inner zipper strip fixing sheet is fixedly connected to the chamber body.

Preferably, the manual pressure-relief valve is adhesively connected to the chamber body. The constant-pressure valves are symmetrically distributed with respect to a vertical centerline of the chamber body.

Preferably, the sealing strip has a U-shaped structure. The sealing strip is adhesively connected to one side of the chamber body.

Compared with the prior art, the present invention has the following beneficial effects:

In the present invention, the material of the chamber body is the soft material. The outer zipper strip and the inner zipper strip both have the U-shaped structures. The chamber body is sealed in a U-shaped method, which can be adapted to various soft air-pressure chambers. A U-shape is a relatively smooth pulling and closing line type of a zipper. When the outer zipper strip and the inner zipper strip are opened, one door-type U-shaped opening is formed. Therefore, whether a human body or the human body carried in a wheelchair or a cart is very convenient to enter the chamber body, which completely changes the opening and closing method of the soft air-pressure chamber. The outer zipper strip is stitched with the chamber door. The inner zipper strip is stitched with the chamber door. The inner zipper strip is stitched with the inner zipper fixing sheet. The inner zipper fixing sheet is fixedly connected to the chamber body. This solves the following problems: the opening and closing method of the soft air-pressure chamber is an opening and closing method of one straight zipper; the opening is very narrow and needs to be opened to both sides so that the human body or the animal can enter the chamber body, which is very inconvenient to use; further, it is impossible for a person with inconvenient mobility to enter the chamber body by means of the wheelchair or the cart, etc. The manual pressure-relief valve is configured to relieve a pressure in the chamber body. The constant-pressure valve can remove the pressure to the outside, which balances the pressure in the chamber at a set value. The sealing strip has the U-shaped structure. The sealing strip can increase air-tightness inside the chamber body, which greatly increases practicability of the vertical soft U-shaped opening and closing sealed air-pressure chamber.

### BRIEF DESCRIPTION OF THE DRAWINGS

FIG. 1 is a front schematic structural diagram of the present invention;

FIG. 2 is a right schematic structural diagram of the present invention;

FIG. 3 is a left schematic structural diagram of the present invention;

FIG. 4 is a rear schematic structural diagram of the present invention;

FIG. 5 is a sectional schematic structural diagram of an outer zipper slider of the present invention.

In the figures: 1. Chamber body; 2. Air inlet; 3. Pressure gauge; 4. Manual pressure-relief valve; 5. Constant-pressure valve; 6. Transparent window; 7. Outer zipper strip; 8. Inner zipper strip; 9. Inner zipper strip fixing sheet; 10. Sealing strip; 11. Connecting point; 12. Outer zipper slider; 13. Inner zipper slider; 14. Folding line; 15. Chamber door.

### DETAILED DESCRIPTION OF EMBODIMENTS

The following clearly and completely describes the technical solution in the embodiments of the present invention in conjunction with the drawings in the embodiments of the present invention. Obviously, the described embodiments are only part of the embodiments of the present invention, rather than all embodiments. Based on the embodiments of the present invention, all other embodiments obtained by those skilled in the art without creative work shall fall within the protection scope of the present invention.

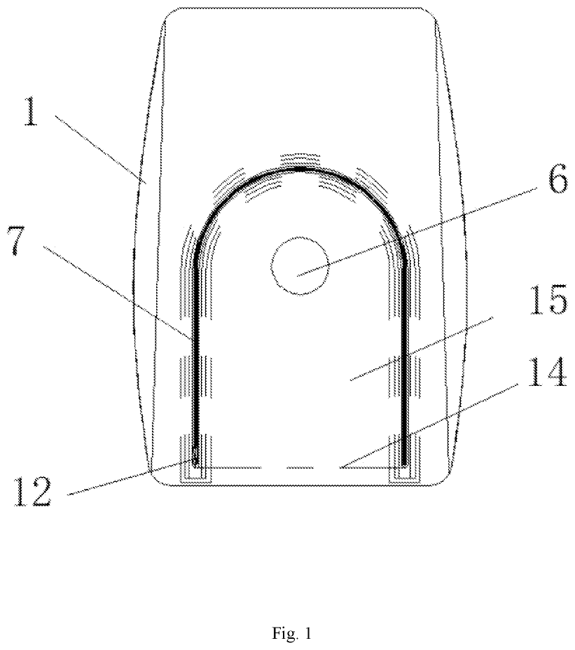

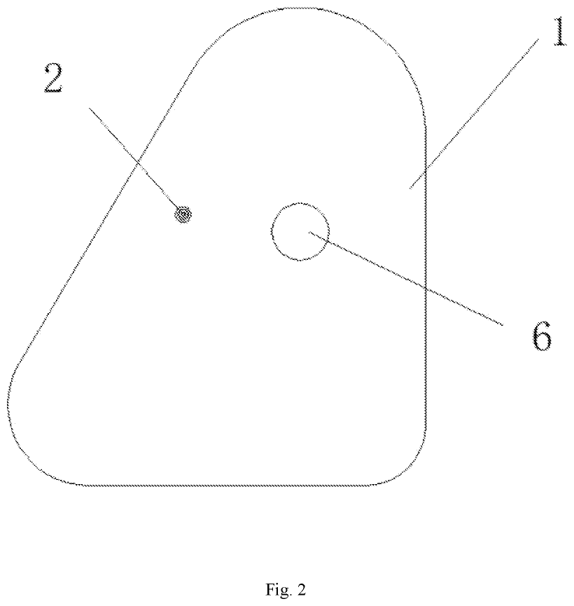

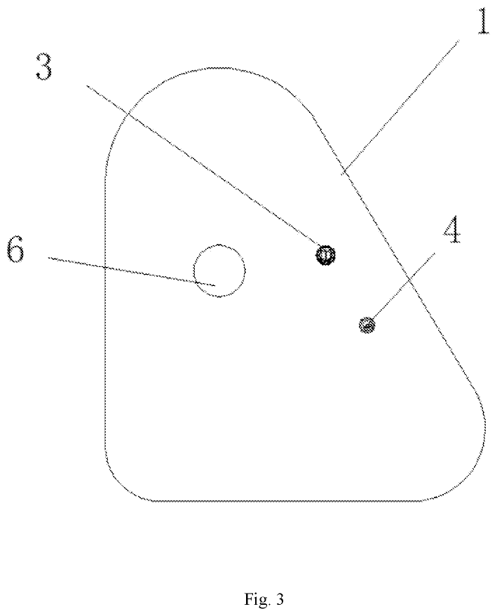

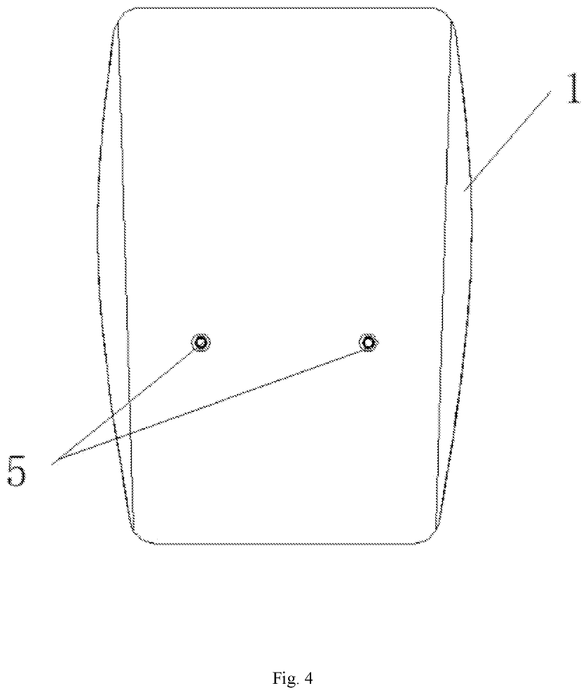

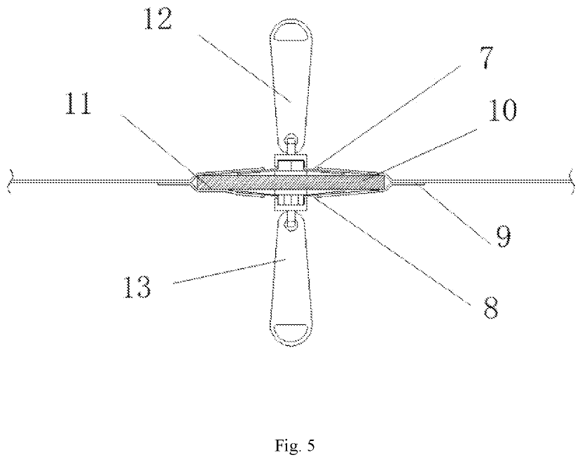

Referring to FIGS. 1-5, the present invention provides a technical solution: a vertical soft U-shaped opening and closing sealed air-pressure chamber comprises a chamber body 1 and an outer zipper strip 7. A chamber door 15 is installed on a front-end surface of the chamber body 1. A transparent window 6 is installed inside the chamber door 15. A folding line 14 is arranged at a lower end of the chamber door 15. The outer zipper strip 7 is installed on a front end of the chamber door 15. An outer zipper slider 12 is installed at an end of the outer zipper strip 7. An inner zipper strip 8 is installed on a rear end surface of the chamber door 15. An inner zipper slider 13 is installed at an end of the inner zipper strip 8. A material of the chamber body 1 is a soft material. The outer zipper strip 7 and the inner zipper strip 8 both have U-shaped structures. The outer zipper strip 7 is stitched with the chamber door 15. The inner zipper strip 8 is stitched with the chamber door 15. The material of the chamber body 1 is the soft material. The outer zipper strip 7 and the inner zipper strip 8 both have the U-shaped structures. The chamber body 1 is sealed in a U-shaped method, which can be adapted to various soft air-pressure chambers. A U-shape is a relatively smooth pulling and closing line type of a zipper. After the outer zipper strip 7 and the inner zipper strip 8 are opened, a door-type U-shaped opening is formed. Therefore, whether a human body or the human body carried in a wheelchair or a cart is very convenient to enter the chamber body, which completely changes the opening and closing method of the soft air-pressure chamber.

A sealing strip 10 is arranged in a middle position between the outer zipper slider 12 and the inner zipper slider 13. An inner zipper strip fixing sheet 9 is installed on a right side of the sealing strip 10. The inner zipper strip 8 is stitched with the inner zipper strip fixing sheet 9. The inner zipper strip fixing sheet 9 is fixedly connected to the chamber body 1. The sealing strip 10 has a U-shaped structure. The sealing strip 10 is adhesively connected to one side of the chamber body 1. The sealing strip 10 has the U-shaped structure. The sealing strip 10 can increase airtightness inside the chamber body 1. This solves the following problems: the opening and closing method of the soft air-pressure chamber is an opening and closing method of one straight zipper; the opening is very narrow and needs to be opened to both sides so that the human body or the animal can enter the chamber body 1, which is very inconvenient to use; further, it is impossible for a person with inconvenient mobility to enter the chamber body 1 by means of the wheelchair or the cart, etc.

A connecting point 11 is provided on a left side of the sealing strip 10. An air inlet 2 is installed on a right end surface of the chamber body 1. A pressure gauge 3 is installed on a left end surface of the chamber body 1. A manual pressure-relief valve 4 is installed below the pressure gauge 3. Constant-pressure valves 5 are installed on a left side and a right side of a rear end surface of the chamber body 1. The manual pressure-relief valve 4 is adhesively connected to the chamber body 1. The constant-pressure valves 5 are symmetrically distributed with respect to a vertical centerline of the chamber body 1. The manual pressure-relief valve 4 is configured to relieve a pressure inside the chamber body 1. The constant-pressure valve 5 can remove the pressure to the outside, which balances the pressure in the chamber at a set value. The sealing strip 10 has the U-shaped structure. The sealing strip 10 can increase the airtightness inside the chamber body 1, which greatly increases practicability of the vertical soft U-shaped opening and closing sealed air-pressure chamber.

Working principle: When the vertical soft U-shaped opening and closing sealed air-pressure chamber is in use, first, the material of the chamber body 1 is the soft material. Air enters an inner part of the chamber body 1 via the air inlet 2. After the outer zipper strip 7 is pulled open by the outer zipper slider 12, the chamber door 15 is opened inward or outward by a folding line 14 to form an open door. When the outer zipper strip 7 and the inner zipper strip 8 are opened, one door-type U-shaped opening is formed. Therefore, whether a human body or the human body carried in a wheelchair or a cart is very convenient to enter the chamber body. Additionally, the human body and the wheelchair can enter the inner part of the chamber body 1. The inner zipper strip 8 is pulled up by the inner zipper slider 13. Use in the inner part of the chamber body 1 can be observed through the transparent window 6. The outer zipper strip 7 and the inner zipper strip 8 both have the U-shaped structures. The chamber body 1 is sealed in the U-shaped method, which can be adapted to various soft air-pressure chambers, and completely changes the opening and closing method of the soft air-pressure chamber. The inner zipper strip fixing sheet 9 can strengthen connection between the inner zipper strip 8 and the chamber body 1. The connecting point 11 is formed between the sealing strip 10 and the chamber body 1, which can increase the airtightness inside the chamber body 1. This avoids the following problems: the opening and closing method of one straight zipper is inconveniently used, and it is impossible for the person with the inconvenient mobility to enter the chamber body 1 by means of the wheelchair or the cart, etc. Inflation pressure inside the chamber body 1 is observed by the pressure gauge 3. The constant-pressure valve 5 can remove the pressure to the outside, which balances the pressure in the chamber at the set value. The manual pressure-relief valve 4 is configured to relieve the pressure inside the chamber body 1. This is the working principle of the vertical soft U-shaped opening and closing sealed air-pressure chamber.

Although the embodiments of the present invention have been shown and described, those skilled in the art can understand that various changes, modifications, substitutions and variants can be made to these embodiments without departing the principle and spirit of the present invention. The scope of the present invention is defined by the appended claims and their equivalents.

What is claimed is:

1. A vertical soft U-shaped opening and closing sealed air-pressure chamber, comprising a chamber body (1) and an outer zipper strip (7), wherein a chamber door (15) is installed on a front end surface of the chamber body (1), a lower end of the chamber door (15) is provided with a folding line (14), the outer zipper strip (7) is installed on a front end surface of the chamber door (15), an outer zipper slider (12) is installed at an end of the outer zipper strip (7), an inner zipper strip (8) is installed on a rear end surface of the chamber door (15), an inner zipper slider (13) is installed at an end of the inner zipper strip (8), a sealing strip (10) is arranged at a middle position between the outer zipper slider (12) and the inner zipper slider (13), an inner zipper strip fixing sheet (9) is installed on a right side of the sealing strip (10), a connecting point (11) is provided on a left side of the sealing strip (10), and the outer zipper strip (7) and the inner zipper strip (8) both have U-shaped structures.

2. The vertical soft U-shaped opening and closing sealed air-pressure chamber according to claim 1, wherein material of the chamber body (1) is a soft material, an air inlet (2) is installed on a right end surface of the chamber body (1), a pressure gauge (3) is installed on a left end surface of the chamber body (1), a manual pressure-relief valve (4) is installed below the pressure gauge (3), constant-pressure valves (5) are installed on a left side and a right side of the rear end surface of the chamber body (1), and a transparent window (6) is installed inside the chamber door (15).

3. The vertical soft U-shaped opening and closing sealed air-pressure chamber according to claim 1, wherein the outer zipper strip (7) is stitched with the chamber door (15), and the inner zipper strip (8) is stitched with the chamber door (15).

4. The vertical soft U-shaped opening and closing sealed air-pressure chamber according to claim 1, wherein the inner zipper strip (8) is stitched with the inner zipper strip fixing sheet (9), and the inner zipper strip fixing sheet (9) is fixedly connected to the chamber body (1).

5. The vertical soft U-shaped opening and closing sealed air-pressure chamber according to claim 2, wherein the manual pressure-relief valve (4) is adhesively connected to the chamber body (1), and the constant-pressure valves (5) are symmetrically distributed with respect to a vertical centerline of the chamber body (1).

6. The vertical soft U-shaped opening and closing sealed air-pressure chamber according to claim 1, wherein the sealing strip (10) has a U-shaped structure, and the sealing strip (10) is adhesively connected to one side of the chamber body (1).
